(19) United States
(12) Patent Application Publication
(10) Pub. No.: US 2024/0113983 A1
(43) Pub. Date: Apr. 4, 2024

(54) DATA DISCARD BASED ON PRIORITY INFORMATION

(71) Applicant: MediaTek Singapore Pte. Ltd, Singapore (SG)

(72) Inventors: Pradeep Jose, Cambridge (GB); Mukesh Chouhan, Cambridge (GB)

(21) Appl. No.: 18/371,538

(22) Filed: Sep. 22, 2023

Related U.S. Application Data
(60) Provisional application No. 63/377,746, filed on Sep. 30, 2022.

(51) Int. Cl. H04L 47/32; H04L 47/2416; H04L 65/80; H04N 19/70

(52) U.S. Cl. CPC H04L 47/32; H04L 47/2416; H04L 65/80; H04N 19/70

(57) ABSTRACT

In an aspect of the disclosure, a method, a computer-readable medium, and an apparatus are provided. The apparatus may be a UE. In certain configurations, the UE determines whether a discarding mechanism is to be applied to a video stream. When the discarding mechanism is to be applied to the video stream, for each video frame of a plurality of frames of the video stream, the UE allocates data of the each video frame to corresponding data units, and assigns a priority level to each unit of the corresponding data units based on an attribute of the each video frame. The UE determines that a communication link for transmitting the plurality of video frames is congested. The UE discards data units of the plurality of video frames based on priority levels of the data units.

### CROSS-REFERENCE TO RELATED APPLICATION(S)

This application claims the benefits of U.S. Provisional Application Ser. No. 63/377,746, entitled “DATA DISCARD BASED ON PRIORITY INFORMATION” and filed on Sep. 30, 2022, which is expressly incorporated by reference herein in their entirety.

### BACKGROUND

### Field

The present disclosure relates generally to communication systems, and more particularly, to techniques of methods and apparatuses about a mechanism to perform data discard based on priority information in a wireless communication.

### Background

The statements in this section merely provide background information related to the present disclosure and may not constitute prior art.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a UE. In certain configurations, the UE determines whether a discarding mechanism is to be applied to a video stream. When the discarding mechanism is to be applied to the video stream, for each video frame of a plurality of frames of the video stream, the UE allocates data of the each video frame to corresponding data units, and assigns a priority level to each unit of the corresponding data units based on an attribute of the each video frame. The UE determines that a communication link for transmitting the plurality of video frames is congested. The UE discards data units of the plurality of video frames based on priority levels of the data units.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2 is a diagram illustrating a base station in communication with a UE in an access network.

FIG. 3 illustrates an example logical architecture of a distributed access network.

FIG. 4 illustrates an example physical architecture of a distributed access network.

FIG. 5 is a diagram showing an example of a DL-centric slot.

FIG. 6 is a diagram showing an example of an UL-centric slot.

FIG. 7 is a diagram illustrating example procedure between a UE and a base station.

FIG. 8 is a diagram illustrating example data frames of video data.

FIG. 9 is a flow chart showing the method (process) of determining whether the preceding frames are to be dropped based on the priority level of the current frame.

FIG. 10 is a diagram illustrating examples of data frames of video data with different current frames at different times.

FIG. 11 is a diagram showing an example procedure of processing video frames to be transmitted.

FIG. 12 is a flow chart of a method (process) for wireless communication of a UE.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunications systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example aspects, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

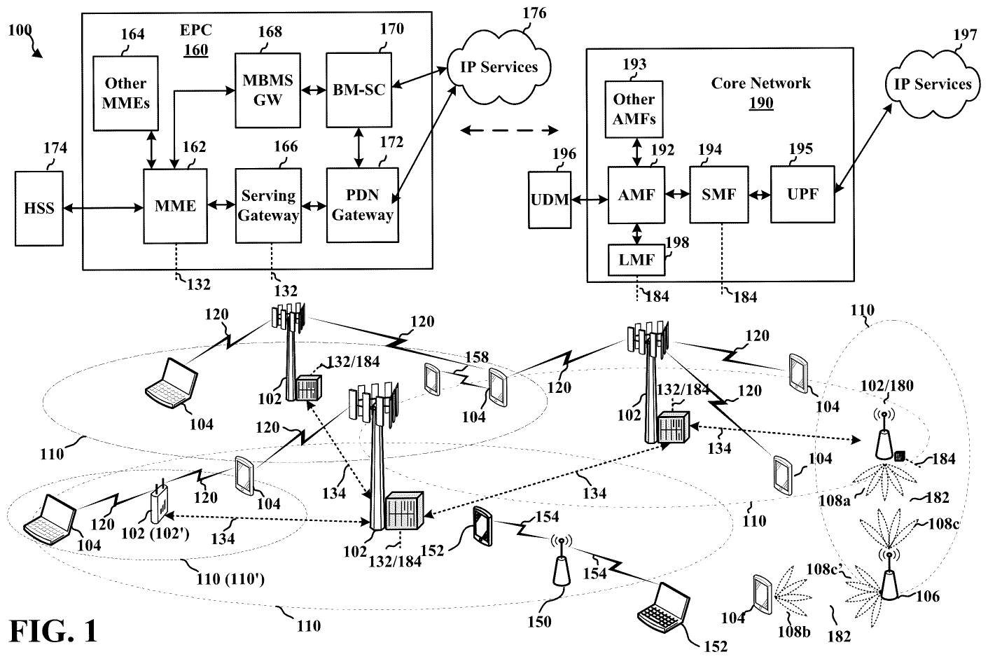

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., SI interface). The base stations 102 configured for 5G NR (collectively referred to as Next Generation RAN (NG-RAN)) may interface with core network 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to 7 MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or another type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band (e.g., 3 GHz-300 GHz) has extremely high path loss and a short range. The mmW base station 180 may utilize beamforming 182 with the UE 104 to compensate for the extremely high path loss and short range.

The base station 180 may transmit a beamformed signal to the UE 104 in one or more transmit directions 108a. The UE 104 may receive the beamformed signal from the base station 180 in one or more receive directions 108b. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a location management function (LMF) 198, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the SMF 194 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the present disclosure may reference 5G New Radio (NR), the present disclosure may be applicable to other similar areas, such as LTE, LTE-Advanced (LTE-A), Code Division Multiple Access (CDMA), Global System for Mobile communications (GSM), or other wireless/radio access technologies.

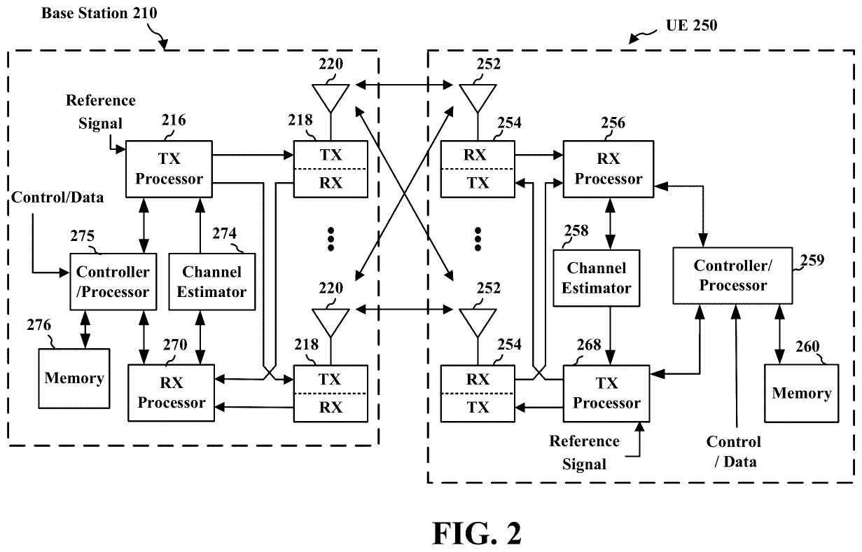

FIG. 2 is a block diagram of a base station 210 in communication with a UE 250 in an access network. In the DL, IP packets from the EPC 160 may be provided to a controller/processor 275. The controller/processor 275 implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer. The controller/processor 275 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 216 and the receive (RX) processor 270 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 216 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 274 may be used to determine the coding and modulation scheme, as well as for spatial processing. The channel estimate may be derived from a reference signal and/or channel condition feedback transmitted by the UE 250. Each spatial stream may then be provided to a different antenna 220 via a separate transmitter 218TX. Each transmitter 218TX may modulate an RF carrier with a respective spatial stream for transmission.

At the UE 250, each receiver 254RX receives a signal through its respective antenna 252. Each receiver 254RX recovers information modulated onto an RF carrier and provides the information to the receive (RX) processor 256. The TX processor 268 and the RX processor 256 implement layer 1 functionality associated with various signal processing functions. The RX processor 256 may perform spatial processing on the information to recover any spatial streams destined for the UE 250. If multiple spatial streams are destined for the UE 250, they may be combined by the RX processor 256 into a single OFDM symbol stream. The RX processor 256 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 210. These soft decisions may be based on channel estimates computed by the channel estimator 258. The soft decisions are then decoded and deinterleaved to recover the data and control signals that were originally transmitted by the base station 210 on the physical channel. The data and control signals are then provided to the controller/processor 259, which implements layer 3 and layer 2 functionality.

The controller/processor 259 can be associated with a memory 260 that stores program codes and data. The memory 260 may be referred to as a computer-readable medium. In the UL, the controller/processor 259 provides demultiplexing between transport and logical channels, packet reassembly, deciphering, header decompression, and control signal processing to recover IP packets from the EPC 160. The controller/processor 259 is also responsible for error detection using an ACK and/or NACK protocol to support HARQ operations.

Similar to the functionality described in connection with the DL transmission by the base station 210, the controller/processor 259 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 258 from a reference signal or feedback transmitted by the base station 210 may be used by the TX processor 268 to select the appropriate coding and modulation schemes, and to facilitate spatial processing. The spatial streams generated by the TX processor 268 may be provided to different antenna 252 via separate transmitters 254TX. Each transmitter 254TX may modulate an RF carrier with a respective spatial stream for transmission. The UL transmission is processed at the base station 210 in a manner similar to that described in connection with the receiver function at the UE 250. Each receiver 218RX receives a signal through its respective antenna 220. Each receiver 218RX recovers information modulated onto an RF carrier and provides the information to a RX processor 270.

The controller/processor 275 can be associated with a memory 276 that stores program codes and data. The memory 276 may be referred to as a computer-readable medium. In the UL, the controller/processor 275 provides demultiplexing between transport and logical channels, packet reassembly, deciphering, header decompression, control signal processing to recover IP packets from the UE 250. IP packets from the controller/processor 275 may be provided to the EPC 160. The controller/processor 275 is also responsible for error detection using an ACK and/or NACK protocol to support HARQ operations.

New radio (NR) may refer to radios configured to operate according to a new air interface (e.g., other than Orthogonal Frequency Divisional Multiple Access (OFDMA)-based air interfaces) or fixed transport layer (e.g., other than Internet Protocol (IP)). NR may utilize OFDM with a cyclic prefix (CP) on the uplink and downlink and may include support for half-duplex operation using time division duplexing (TDD). NR may include Enhanced Mobile Broadband (eMBB) service targeting wide bandwidth (e.g. 80 MHz beyond), millimeter wave (mmW) targeting high carrier frequency (e.g. 60 GHz), massive MTC (mMTC) targeting non-backward compatible MTC techniques, and/or mission critical targeting ultra-reliable low latency communications (URLLC) service.

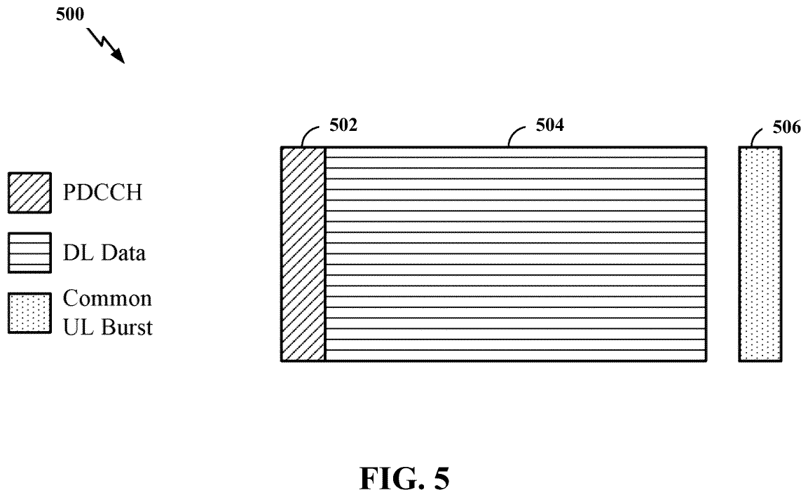

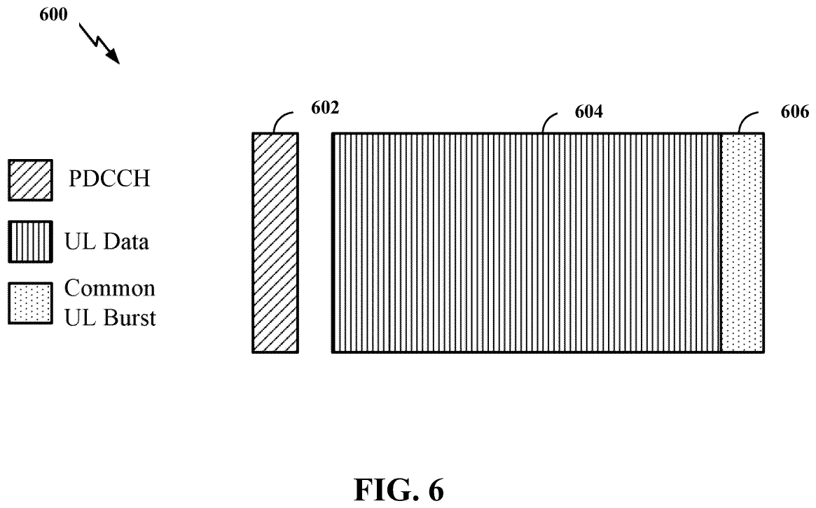

A single component carrier bandwidth of 100 MHz may be supported. In one example, NR resource blocks (RBs) may span 12 sub-carriers with a sub-carrier bandwidth of 60 kHz over a 0.25 ms duration or a bandwidth of 30 kHz over a 0.5 ms duration (similarly, 50 MHz BW for 15 kHz SCS over a 1 ms duration). Each radio frame may consist of 10 subframes (10, 20, 40 or 80 NR slots) with a length of 10 ms. Each slot may indicate a link direction (i.e., DL or UL) for data transmission and the link direction for each slot may be dynamically switched. Each slot may include DL/UL data as well as DL/UL control data. UL and DL slots for NR may be as described in more detail below with respect to FIGS. 5 and 6.

The NR RAN may include a central unit (CU) and distributed units (DUs). A NR BS (e.g., gNB, 5G Node B, Node B, transmission reception point (TRP), access point (AP)) may correspond to one or multiple BSs. NR cells can be configured as access cells (ACells) or data only cells (DCells). For example, the RAN (e.g., a central unit or distributed unit) can configure the cells. DCells may be cells used for carrier aggregation or dual connectivity and may not be used for initial access, cell selection/reselection, or handover. In some cases DCells may not transmit synchronization signals (SS) in some cases DCells may transmit SS. NR BSs may transmit downlink signals to UEs indicating the cell type. Based on the cell type indication, the UE may communicate with the NR BS. For example, the UE may determine NR BSs to consider for cell selection, access, handover, and/or measurement based on the indicated cell type.

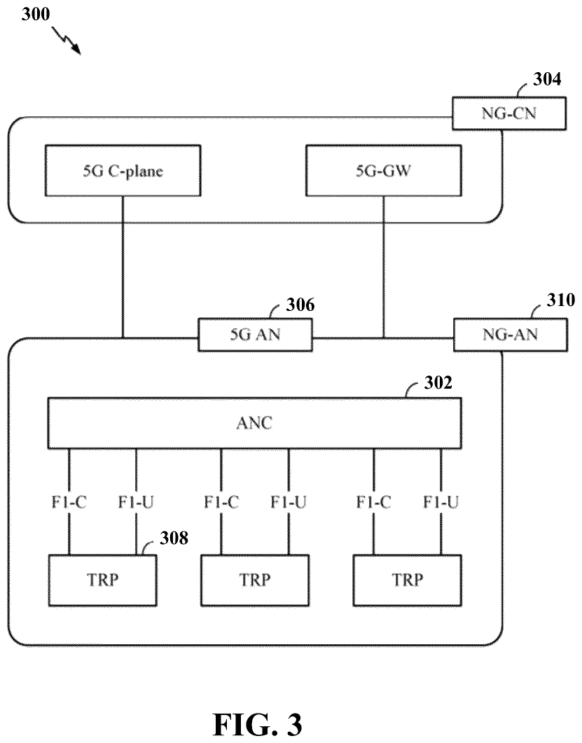

FIG. 3 illustrates an example logical architecture of a distributed RAN 300, according to aspects of the present disclosure. A 5G access node 306 may include an access node controller (ANC) 302. The ANC may be a central unit (CU) of the distributed RAN. The backhaul interface to the next generation core network (NG-CN) 304 may terminate at the ANC. The backhaul interface to neighboring next generation access nodes (NG-ANs) 310 may terminate at the ANC. The ANC may include one or more TRPs 308 (which may also be referred to as BSs, NR BSs, Node Bs, 5G NBs, APs, or some other term). As described above, a TRP may be used interchangeably with “cell.”

The TRPs 308 may be a distributed unit (DU). The TRPs may be connected to one ANC (ANC 302) or more than one ANC (not illustrated). For example, for RAN sharing, radio as a service (RaaS), and service specific ANC deployments, the TRP may be connected to more than one ANC. A TRP may include one or more antenna ports. The TRPs may be configured to individually (e.g., dynamic selection) or jointly (e.g., joint transmission) serve traffic to a UE.

The local architecture of the distributed RAN 300 may be used to illustrate fronthaul definition. The architecture may be defined that support fronthauling solutions across different deployment types. For example, the architecture may be based on transmit network capabilities (e.g., bandwidth, latency, and/or jitter). The architecture may share features and/or components with LTE. According to aspects, the next generation AN (NG-AN) 310 may support dual connectivity with NR. The NG-AN may share a common fronthaul for LTE and NR.

The architecture may enable cooperation between and among TRPs 308. For example, cooperation may be preset within a TRP and/or across TRPs via the ANC 302. According to aspects, no inter-TRP interface may be needed/present.

According to aspects, a dynamic configuration of split logical functions may be present within the architecture of the distributed RAN 300. The PDCP, RLC, MAC protocol may be adaptably placed at the ANC or TRP.

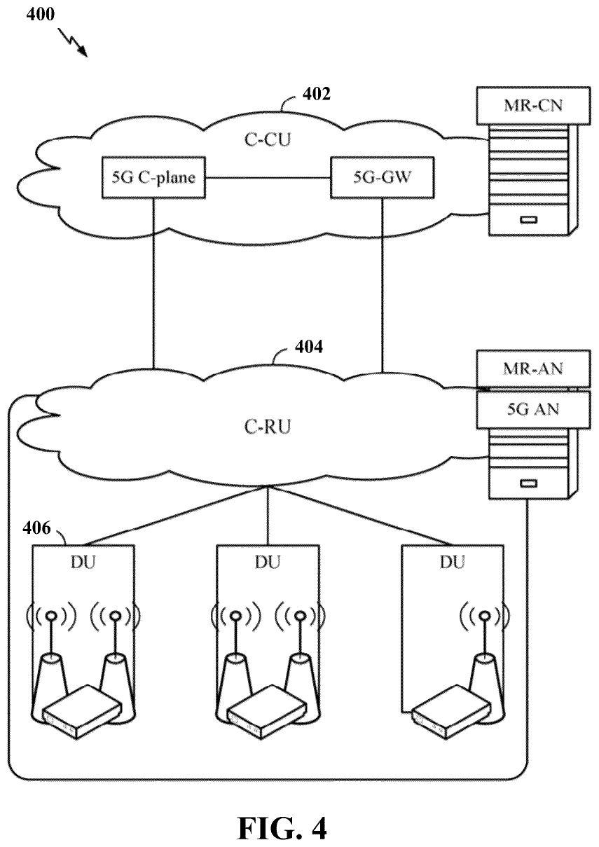

FIG. 4 illustrates an example physical architecture of a distributed RAN 400, according to aspects of the present disclosure. A centralized core network unit (C-CU) 402 may host core network functions. The C-CU may be centrally deployed. C-CU functionality may be offloaded (e.g., to advanced wireless services (AWS)), in an effort to handle peak capacity. A centralized RAN unit (C-RU) 404 may host one or more ANC functions. Optionally, the C-RU may host core network functions locally. The C-RU may have distributed deployment. The C-RU may be closer to the network edge. A distributed unit (DU) 406 may host one or more TRPs. The DU may be located at edges of the network with radio frequency (RF) functionality.

FIG. 5 is a diagram 500 showing an example of a DL-centric slot. The DL-centric slot may include a control portion 502. The control portion 502 may exist in the initial or beginning portion of the DL-centric slot. The control portion 502 may include various scheduling information and/or control information corresponding to various portions of the DL-centric slot. In some configurations, the control portion 502 may be a physical DL control channel (PDCCH), as indicated in FIG. 5. The DL-centric slot may also include a DL data portion 504. The DL data portion 504 may sometimes be referred to as the payload of the DL-centric slot. The DL data portion 504 may include the communication resources utilized to communicate DL data from the scheduling entity (e.g., UE or BS) to the subordinate entity (e.g., UE). In some configurations, the DL data portion 504 may be a physical DL shared channel (PDSCH).

The DL-centric slot may also include a common UL portion 506. The common UL portion 506 may sometimes be referred to as an UL burst, a common UL burst, and/or various other suitable terms. The common UL portion 506 may include feedback information corresponding to various other portions of the DL-centric slot. For example, the common UL portion 506 may include feedback information corresponding to the control portion 502. Non-limiting examples of feedback information may include an ACK signal, a NACK signal, a HARQ indicator, and/or various other suitable types of information. The common UL portion 506 may include additional or alternative information, such as information pertaining to random access channel (RACH) procedures, scheduling requests (SRs), and various other suitable types of information.

As illustrated in FIG. 5, the end of the DL data portion 504 may be separated in time from the beginning of the common UL portion 506. This time separation may sometimes be referred to as a gap, a guard period, a guard interval, and/or various other suitable terms. This separation provides time for the switch-over from DL communication (e.g., reception operation by the subordinate entity (e.g., UE)) to UL communication (e.g., transmission by the subordinate entity (e.g., UE)). One of ordinary skill in the art will understand that the foregoing is merely one example of a DL-centric slot and alternative structures having similar features may exist without necessarily deviating from the aspects described herein.

FIG. 6 is a diagram 600 showing an example of an UL-centric slot. The UL-centric slot may include a control portion 602. The control portion 602 may exist in the initial or beginning portion of the UL-centric slot. The control portion 602 in FIG. 6 may be similar to the control portion 502 described above with reference to FIG. 5. The UL-centric slot may also include an UL data portion 604. The UL data portion 604 may sometimes be referred to as the pay load of the UL-centric slot. The UL portion may refer to the communication resources utilized to communicate UL data from the subordinate entity (e.g., UE) to the scheduling entity (e.g., UE or BS). In some configurations, the control portion 602 may be a physical DL control channel (PDCCH).

As illustrated in FIG. 6, the end of the control portion 602 may be separated in time from the beginning of the UL data portion 604. This time separation may sometimes be referred to as a gap, guard period, guard interval, and/or various other suitable terms. This separation provides time for the switch-over from DL communication (e.g., reception operation by the scheduling entity) to UL communication (e.g., transmission by the scheduling entity). The UL-centric slot may also include a common UL portion 606. The common UL portion 606 in FIG. 6 may be similar to the common UL portion 506 described above with reference to FIG. 5. The common UL portion 606 may additionally or alternatively include information pertaining to channel quality indicator (CQI), sounding reference signals (SRSs), and various other suitable types of information. One of ordinary skill in the art will understand that the foregoing is merely one example of an UL-centric slot and alternative structures having similar features may exist without necessarily deviating from the aspects described herein.

In some circumstances, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum).

Extended reality (XR) is an umbrella term for applications and services related to virtual reality (VR), augmented reality (AR), and cloud gaming (CG). When a UE is a connection supporting an XR application service with a base station (e.g., gNB), the UE may transmit data packets to the base station in periodic XR traffic.

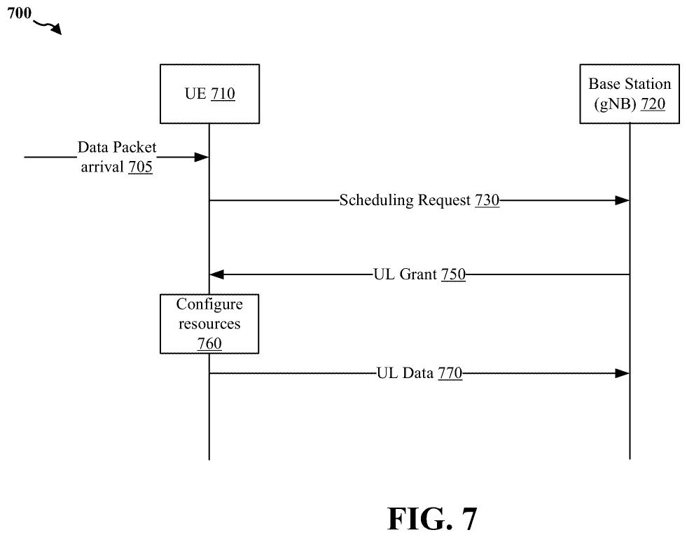

FIG. 7 is a diagram illustrating an example transmission procedure between a UE and a base station. As shown in FIG. 7, at operation 705, the UE 710 may receive a data packet, i.e., the packet arrival. At this time, the UE 710 determines whether the base station 720 (e.g., gNB) has sent a configuration instruction for configuring the UE 710 to provide UL resources. If the UE 710 has no UL resources available, at operation 730, the UE 710 may send a scheduling request (SR) to the base station 720, and in response to the SR, at operation 750, the base station 720 sends a UL grant back to the UE 710 to configure the UE 710 with the UL resources. Once receiving the UL grant, at operation 760, the UE 710 may configure the resources based on the UL grant, such that the UL resources are available. Then, at operation 770, the UE 710 may send the UL data to the base station 720.

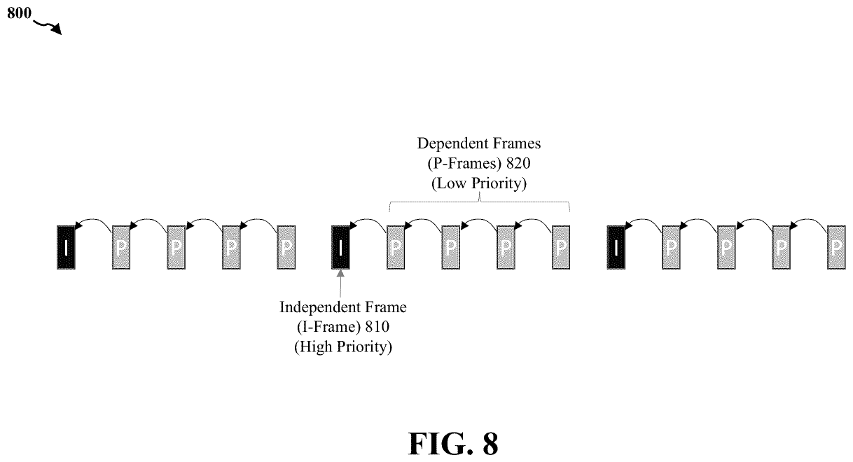

The video component of the XR traffic is the most data-intensive traffic flow, and optimizing the amount of the video traffic to send will help improve the capacity of the wireless communication links. FIG. 8 is a diagram illustrating example data frames of video data 800. Currently, video codecs generate video frames that may be dependent on previous frames, and the common practice to optimize the video frame size is to have differential information, i.e., a frame including only information that is different from the previous frame. Independent information needs to be provided to handle frame losses. For example, as shown in FIG. 8, when the UE 710 transmits video data 800 to the base station 720 with a group of pictures (GOP) approach, the periodic traffic includes groups of I-frames 810 and P-frames 820. Specifically, each I-frame 810 is a complete video frame that contains standalone information with a much larger packet size, and is followed by a set of P-frames 820 that are differentially encoded. Each P-frame 820 is a delta frame of a preceding frame (which may be an I-frame 810 or a P-frame 820), with a smaller packet size interpolated between two consecutive I-frames 810. Each I-frame 810 is an independent frame, which is independent of the previous frame, and each P-frame 820 is a dependent frame, which is dependent on the previous frame.

Given that the video data 800 has a mix of the independent frames (i.e., I-frames 810) and dependent frames (i.e., P-frames 820), it is possible to provide a mechanism to differentiate the two types of frames by assigning priority to each frame when transmitting the video data over a communication system. Specifically, each dependent frame (i.e., P-frame 820) cannot be set to a priority level that is higher than the priority level of its preceding frame, as the dependent frame (i.e., P-frame 820) is dependent on the preceding frame(s). Thus, the preceding frame(s) must be first received in order to process the current dependent frame, and there is no point prioritizing the transmission of the current dependent frame over the preceding frame(s). On the other hand, each independent frame (i.e., I-frame 810) can be set to a priority level that is higher than the priority level its preceding frame, as the independent frame (i.e., I-frame 810) is independent of the preceding frame(s). Thus, the transmission of the current independent frame may be prioritized over earlier frames of lower priority, as the independent frame may be independently processed. In other words, each independent frame (i.e., I-frame 810) is assigned with a priority level that is higher than a preceding priority level of a preceding frame, and each dependent frame (i.e., P-frame 820) is assigned with a priority level that is not higher than a preceding priority level of its preceding frame.

In certain configurations, the mechanism may work with multiple priority levels. For example, as shown in FIG. 7, the frames of the video data 800 are assigned with two different priority levels, with each independent frame (i.e., I-frame 810) is assigned with a high priority, and each dependent frame (i.e., P-frame 820) is assigned with a low priority. In certain configurations, the mechanism may work with additional priority levels defined for different types of data. Alternatively, the mechanism may work with only two priority levels (e.g., high priority and low priority), in which a single priority indication may be sufficient to indicate the priority of each frame.

In certain configurations, the UE 710 may be configured such that, when there is a backlog of the video data 800 to be transmitted over a communication link, a newly arriving frame with a higher priority level may be prioritized for transmission over the transmission of existing preceding lower priority frames. Specifically, when the backlog exists, the UE 710 at the PDCP layer is aware of the backlog due to the frames being queued in the PDCP, RLC or MAC layers. In this case, the UE 710 may determine, based on the priority level of the newly arrived frame, whether there is a need to discard or drop the earlier frames.

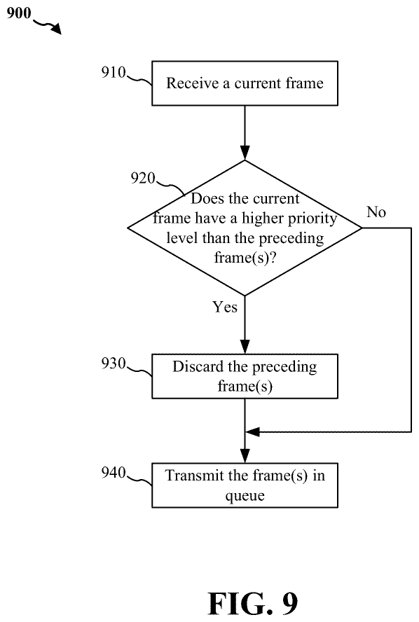

FIG. 9 is a flow chart showing the method (process) of determining whether the preceding frames are to be dropped based on the priority level of the current frame. As shown in FIG. 9, at operation 910, the UE 710 receives a current frame (i.e., the newly arrived frame), which is assigned with a corresponding priority. For example, if the current frame is an independent frame (i.e., I-frame 810), the current frame has a high priority, and if the current frame is a dependent frame (i.e., P-frame 820), the current frame has a low priority. At operation 920, the UE 710 compares the priority level of the current frame with the priority level of its preceding frame(s) to determine whether the current frame has a higher priority level than the preceding frame(s). If the current frame arrives with a lower priority level (e.g., P-frame 820), the UE 710 does nothing with the earlier higher priority frames. On the other hand, if the current frame arrives with a higher priority level (e.g., I-frame 810), the UE 710 may determine that the newly arrived frame with the higher priority level contains the latest video information, such that the earlier low priority frames can be dropped to reduce the capacity and buffer impacts of the transmission of the low priority data, which leads to a reduction in radio resource usage. Thus, at operation 930, the UE discards the preceding frame(s). At operation 940, the UE transmits the frame(s) in queue.

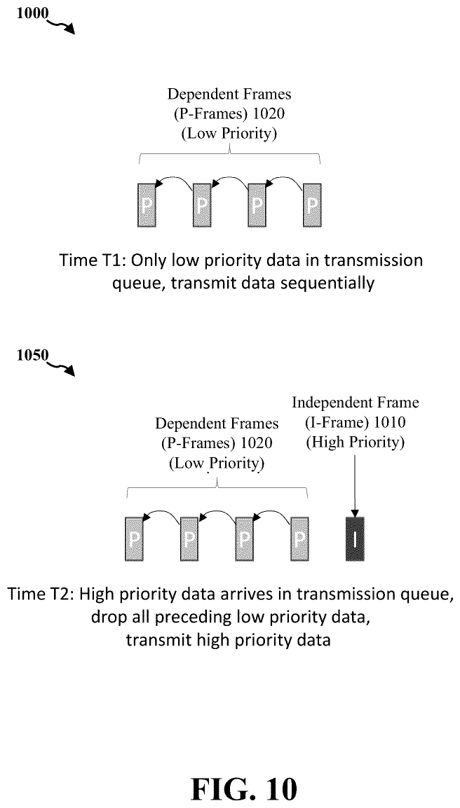

FIG. 10 is a diagram illustrating examples of data frames of video data with different current frames. At time T1, there are only dependent frames (i.e., P-frames 1020) with the low priority in the transmission queue 1000, and the current frame (i.e., the latest frame arrived) is also a dependent frame. In this case, no preceding frames are dropped/discarded. At time T2, when an independent frame (i.e., I-frame 1010) with the high priority arrives in the transmission queue 1050 to become the current frame, the preceding frames, which are all dependent frames (i.e., P-frames 1020) with the low priority, are dropped, such that the UE 710 may transmit the independent frame 1010.

It should be noted that the mechanism as disclosed makes sense in the case of real time or streaming communications, where it is important to provide the latest video information. On the other hand, in case of buffered video streams, it may be better to transmit all data frames and not prioritize or drop any of the data frames. Therefore, the use of this prioritization mechanism may be configurable for the UE 710 such that it applies to only certain scenarios. For example, in certain configurations, the base station 720 may generate a corresponding configuration instruction for configuring the UE 710 by the application function in the core network, the UE 710 may be configurable based on the configuration instruction from the base station 720 to transmit the video data frame-to-frame sequentially or based on the priority of the frames. Alternatively, in certain configurations, the UE 710 may be configured by one or more applications running on the UE 710 to transmit the video data frame-to-frame sequentially or based on the priority of the frames. In this case, different applications running on the UE 710 may have different configurations, such that one application may choose to transmit the video data frame-to-frame sequentially, and another application may choose to transmit the video data based on the priority of the frames.

In certain configurations, the mechanism may be deployed in any wireless communication system, such as 3GPP, Wi-Fi, BT, etc., to reduce the radio resource usage. Using the 3GPP system as an example, the mechanism may be deployed in either of the SDAP, PDCP, RLC or MAC layers.

In the example as shown in FIG. 8, the video data 800 includes the frames. In certain configurations, the data to be transmitted by the UE 710 may be in different forms, which may refer to as being formed by different data units, such as frames, protocol data units (PDUs) or PDU sets.

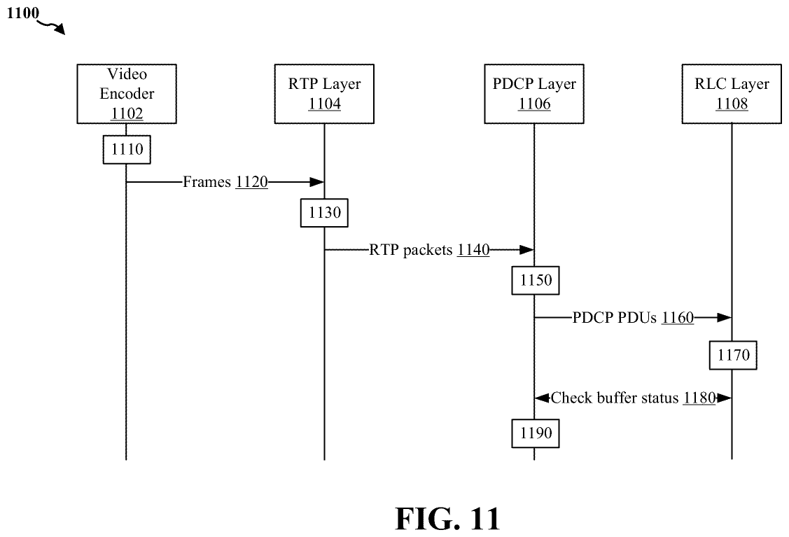

FIG. 11 is a diagram 1100 illustrating an example procedure of processing video frames to be transmitted. Specifically, the procedure is performed on a UE (e.g., the UE 710). At operation 1110, a video codec 1102 generates the video frames, and assigns corresponding priority to each video frame generated. Specifically, the video frames generated by the video codec 1102 include independent frames (i.e., I-frames 810) and dependent frames (i.e., P-frames 820), and the priority level being assigned to each of the video frames may be implemented in a way as shown in FIG. 8. At operation 1120, the video codec 1102 sends the video frames generated to the RTP layer 1104 as payload data. At operation 1130, the RTP layer 1104 processes each video frame to generate corresponding RTP packets, which encapsulate certain portions of the data of the video frame. Specifically, at the RTP layer 1104, a single video frame may be segmented to span multiple RTP packets, and each RTP packet may contain a fragment of the video frame. In certain configurations, the priority information being assigned to each video frame is also marked in the header of each RTP packet. In particular, the RTP protocol provides a header extension mechanism that allows extra information to be included, and the priority metadata may be added in the RTP header such that the RTP packets carrying the data of the video frames also have the corresponding priority information.

At operation 1140, the RTP layer 1104 forwards the RTP packets to the PDCP layer 1106. At operation 1150, the PDCP layer 1106 segments the RTP packets (which carry the data of the video frames) and allocates the fragments to PDCP PDUs based on the PDU size. Specifically, the PDCP layer 1106 adds its own PDCP header to each PDCP PDU, and the PDCP header is separate from the RTP header of the payload of each PDCP PDU. Throughout the process, the priority marking in the RTP header stays with the packet payload end-to-end and determines the priority of the PDCP PDUs carrying the frame data. The PDCP PDUs generated at the PDCP layer 1106 are stored in the PDCP buffer for further process.

At operation 1160, in the case where data transmission is smooth (i.e., there is no data congestion or backlog in the wireless communication link), the PDCP layer 1106 sends the PDCP PDUs to the RLC layer 1108. At operation 1170, the RLC layer 1108 further segments the PDCP PDUs and allocates the fragments to RLC PDUs as needed, such that the RLC PDUs may be buffered at the RLC layer 1108 for transmission. In this case, data may get backlogged at the RLC layer 1108 when the wireless communication link is congested and grants cannot be obtained. At operation 1180, the PDCP layer 1106 checks the buffer status at the RLC layer 1108. Specifically, the PDCP layer 1106 may query the buffer status from the RLC layer 1108, or alternatively, the RLC layer 1108 may report the buffer status to the PDCP layer 1106. Thus, the PDCP layer 1106 can determine the RLC buffer status, and knows when congestion is occurring. When the PDCP layer 1106 determines that a backlog at the RLC buffer occurs, and a high priority PDU arrives at PDCP, at operation 1190, the PDCP layer 1106 discards lower priority PDCP PDUs from its own buffer. In other words, the discard occurs at the PDCP layer 1106 to selectively drop the lower priority PDCP PDUs from the PDCP buffer. Specifically, an interface between the RTP layer 1104 and the PDCP layer 1106 would allow the priority information to be extracted from the RTP header and conveyed to the PDCP layer 1106. This allows the high priority PDCP PDU to be passed down to the RLC layer 1108, assembled into a transport block, and transmitted.

In the procedure, the video frames may be processed and transmitted in a single stream or in multiple streams. For example, in certain configurations, the UE 710 may have different applications running thereon to transmit video data, and the RTP layer 1104 may differentiate the RTP header extension with the priority information between streams from the different applications. The streams may be mapped to different Quality of Service (QoS) flows and logical channels. In this case, the discard configuration may be done at any of the QoS flow, logical channel or radio bearer levels. Accordingly, priority discard may be enabled for one QoS flow related to a first stream, but not another QoS flow related to a second stream. Mapping independent and dependent frames to different QoS flows or logical channels allows configuring discard per flow/channel.

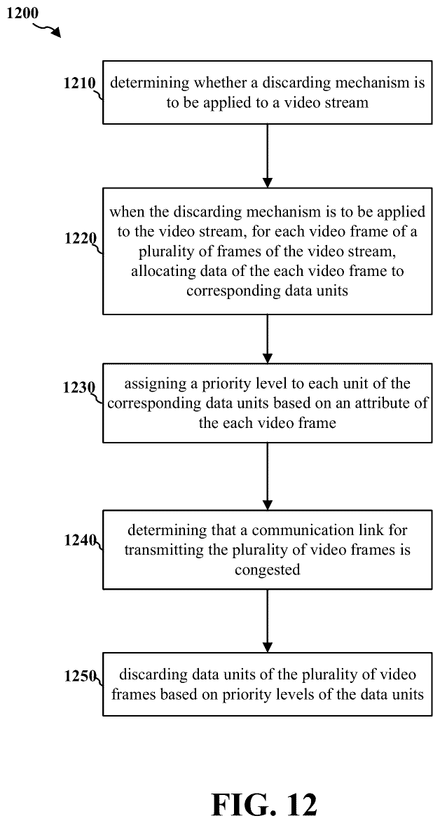

FIG. 12 is a flow chart of a method (process) for wireless communication of a UE. The method may be performed by a UE (e.g., the UE 710). At operation 1210, the UE determines whether a discarding mechanism is to be applied to a video stream. When the discarding mechanism is to be applied to the video stream, for each video frame of a plurality of frames of the video stream, at operation 1220, the UE allocates data of the each video frame to corresponding data units, and at operation 1230, the UE assigns a priority level to each unit of the corresponding data units based on an attribute of the each video frame. At operation 1240, the UE determines that a communication link for transmitting the plurality of video frames is congested. At operation 1250, the UE discards data units of the plurality of video frames based on priority levels of the data units.

In certain configurations, the attribute of the each video frame comprises whether the each video frame is an independent frame or a dependent frame.

In certain configurations, data units corresponding to independent frames are assigned higher priority levels than data units corresponding to dependent frames.

In certain configurations, priority levels of data units corresponding to a given dependent frame are not higher than priority levels of data units of a frame preceding to the given dependent frame, and the given dependent frame is dependent on the frame preceding to the given dependent frame.

In certain configurations, discarding the data units comprises: in response to receiving a current data unit having a higher priority level than a preceding data unit, discarding the preceding data unit.

In certain configurations, the communication link comprises a radio link between the UE and a base station.

In certain configurations, assigning the priority level is performed at a MAC layer, a RLC layer, a SDAP layer, or a PDCP layer.

In certain configurations, whether the discarding mechanism is to be applied to a video stream is determined based on a source of the video stream.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication of a user equipment (UE), comprising:
determining whether a discarding mechanism is to be applied to a video stream;
when the discarding mechanism is to be applied to the video stream:
for each video frame of a plurality of frames of the video stream:
allocating data of the each video frame to corresponding data units; and
assigning a priority level to each unit of the corresponding data units based on an attribute of the each video frame;
determining that a communication link for transmitting the plurality of video frames is congested; and
discarding data units of the plurality of video frames based on priority levels of the data units.

2. The method of claim 1, wherein the attribute of the each video frame comprises whether the each video frame is an independent frame or a dependent frame.

3. The method of claim 2, wherein data units corresponding to independent frames are assigned higher priority levels than data units corresponding to dependent frames.

4. The method of claim 2, wherein priority levels of data units corresponding to a given dependent frame are not higher than priority levels of data units of a frame preceding to the given dependent frame, wherein the given dependent frame is dependent on the frame preceding to the given dependent frame.

5. The method of claim 1, wherein discarding the data units comprises:
in response to receiving a current data unit having a higher priority level than a preceding data unit, discarding the preceding data unit.

6. The method of claim 1, wherein the communication link comprises a radio link between the UE and a base station.

7. The method of claim 1, wherein assigning the priority level is performed at a medium access control (MAC) layer, a radio link control (RLC) layer, a service data adaptation Protocol (SDAP) layer, or a packet data convergence protocol (PDCP) layer.

8. The method of claim 1, wherein whether the discarding mechanism is to be applied to a video stream is determined based on a source of the video stream.

9. An apparatus for wireless communication, the apparatus being a user equipment (UE), comprising:
a memory; and
at least one processor coupled to the memory and configured to:
determine whether a discarding mechanism is to be applied to a video stream;
when the discarding mechanism is to be applied to the video stream:
for each video frame of a plurality of frames of the video stream:
allocate data of the each video frame to corresponding data units; and
assign a priority level to each unit of the corresponding data units based on an attribute of the each video frame;
determine that a communication link for transmitting the plurality of video frames is congested; and
discard data units of the plurality of video frames based on priority levels of the data units.

10. The apparatus of claim 9, wherein the attribute of the each video frame comprises whether the each video frame is an independent frame or a dependent frame.

11. The apparatus of claim 10, wherein data units corresponding to independent frames are assigned higher priority levels than data units corresponding to dependent frames.

12. The apparatus of claim 10, wherein priority levels of data units corresponding to a given dependent frame are not higher than priority levels of data units of a frame preceding to the given dependent frame, wherein the given dependent frame is dependent on the frame preceding to the given dependent frame.

13. The apparatus of claim 9, wherein discarding the data units comprises:
in response to receiving a current data unit having a higher priority level than a preceding data unit, discarding the preceding data unit.

14. The apparatus of claim 9, wherein the communication link comprises a radio link between the UE and a base station.

15. The apparatus of claim 9, wherein assigning the priority level is performed at a medium access control (MAC) layer, a radio link control (RLC) layer, a service data adaptation Protocol (SDAP) layer, or a packet data convergence protocol (PDCP) layer.

16. The method of claim 9, wherein whether the discarding mechanism is to be applied to a video stream is determined based on a source of the video stream.

17. A computer-readable medium storing computer executable code for wireless communication of a user equipment (UE), comprising code to:
determine whether a discarding mechanism is to be applied to a video stream;
when the discarding mechanism is to be applied to the video stream:
for each video frame of a plurality of frames of the video stream:
allocate data of the each video frame to corresponding data units; and
assign a priority level to each unit of the corresponding data units based on an attribute of the each video frame;
determine that a communication link for transmitting the plurality of video frames is congested; and
discard data units of the plurality of video frames based on priority levels of the data units.

18. The computer-readable medium of claim 17, wherein the attribute of the each video frame comprises whether the each video frame is an independent frame or a dependent frame.

19. The computer-readable medium of claim 18, wherein data units corresponding to independent frames are assigned higher priority levels than data units corresponding to dependent frames.

20. The computer-readable medium of claim 18, wherein priority levels of data units corresponding to a given dependent frame are not higher than priority levels of data units of a frame preceding to the given dependent frame, wherein the given dependent frame is dependent on the frame preceding to the given dependent frame.
